(19) United States
(12) Patent Application Publication
(10) Pub. No.: US 2006/0218213 A1
(43) Pub. Date: Sep. 28, 2006

(54) Optimization technique for FIR and IIR filter design

(76) Inventors: Shereef Shehata, Allen, TX (US); Jason Meiners, Richardson, TX (US)

Correspondence Address: TEXAS INSTRUMENTS INCORPORATED, P O BOX 655474, M/S 3999, DALLAS, TX, 75265, US

(21) Appl. No.: 11/089,178

(22) Filed: Mar. 24, 2005

(51) Int. Cl. G06F 17/10

(52) U.S. Cl. 708/300

(57) ABSTRACT

A method for optimizing a digital filter that produces an output signal from samples of an input signal is configured with filter coefficients that are selected by a prescribed filter coefficient search. The filter coefficient search uses a pre-scaling constant or an additive constant with the filter coefficients and canonical signed digits to reduce filter cost or filter execution time. The coefficient search includes a precision for the filter coefficients and an allowable number of nonzero digits for each coefficient to produce a filter coefficient set with a reduced overall number of nonzero digits. The resulting filter can generally be implemented with substantially less integrated circuit die area than that obtainable with previous design approaches.

### TECHNICAL FIELD

This invention relates generally to hardware and software implementations of discrete-time signal processing filters, and, in particular, to implementations of finite-time impulse response (FIR) filters and infinite-time impulse response (IIR) filters configured with an integrated circuit or with software.

### BACKGROUND

Linear filters implemented with digital signal processing, generally with constant coefficients, are widely used in electronic systems, particularly in systems configured with digital logic. For example, digital filters are widely used in cellular telephones, speakerphones, high performance television and radio receivers, speech recognition, and numerous other applications requiring linear processing of a band-limited signal. To achieve high filtering performance such as a flat pass band, a flat stop band, and a steep inter-band transition, high order filters are generally required. The number of filter delay taps required to implement an FIR filter with a pass-band ripple of ±r₁ centered around unity, a stop-band ripple of ±r₂ centered around zero, a transition bandwidth of Fₜᵣₐₙₛᵢₜᵢₒₙ Hz, and a sampling frequency of F_{sampling} Hz is approximately (as described by R. A. Haddad, et al., “Digital Signal Processing: Theory, Applications and Hardware,” W.H. Freeman and Co., 1991, p. 199)

$$\frac{- 10 \cdot {log}_{10} ( {r}_{1} \cdot {r}_{2} ) - 13}{14.6 \cdot \frac{{F}_{transition}}{{F}_{sampling}}} + 1.$$

Digital filters with 50 or 100 or more delay taps are not uncommon for known high performance filters with narrow transition bandwidths.

Filters configured with many taps inherently require that a significant number of digital operations be performed at a high repetition rate. This, in turn, requires that substantial chip area must be dedicated when a high order filter is implemented with an integrated circuit, or else a high performance digital signal processor must be designed into the end product. Either of these alternatives can result in a recognizable cost and power increase in the end product, and, for portable systems, a reduction in battery life.

Digital filters can be implemented with a discrete-time structure that corresponds directly to the structure of traditional lumped-parameter analog filters. Such discrete filters are usually described as infinite-duration impulse response (IIR) filters because, being filters characterized with stability and causality, they produce a finite (and diminishing) output signal response over any time period after a time-limited signal is applied to its input. IIR filters require careful consideration of stability in their design as well as the effects of quantization resulting from computation with a limited number of bits.

Finite-duration impulse response (FIR) filters, so named because a time-limited signal at its input produces a time-limited signal at its output, are a known alternative to IIR filters. FIR filters do not exhibit stability problems because their non-recursive structure produces an output signal that only depends on ordinary numerical operations on an input signal with limited time delays. FIR filters have no corresponding lumped-parameter analog equivalent. FIR filters are less dependant on numerical quantization and, unlike IIR filters, can be easily designed without significant phase error that would otherwise contribute to waveform distortion of the output signal. But a high performance FIR filter, like a corresponding IIR filter, brings a system cost for substantial numerical computation, particularly for multiplication of the input signal by a filter coefficient for each of the many filter taps.

A focused research effort has been made over the past decades to reduce the necessary computation for digital filters, particularly for high order FIR filters, and has produced several significant results. An article by J. O. Coleman, et al., “Fractions in the Canonical-Signed Digit Number System,” 2001 Conf. on Information Sciences and Systems, Mar. 21, 2001, pp. 1-2, which is referenced and incorporated herein, describes the use of canonical signed digits (CSD) for the representation of binary numbers. Using a CSD representation recognizes and takes advantage of the fact that subtraction is no more complex than addition in binary arithmetic and both are much simpler than multiplication which is generally implemented with a series of resource-consuming shifts and adds corresponding to the number of “1” bits in the multiplier.

CSD advantageously extends the binary character set to a ternary coefficient set by including negative binary digits such as the binary digit “1” that represents the negative digit “−1”. The representation of a general binary number using ternary digits is not unique because the binary number 11111 (equivalent to “31 ” in base 10) can also be represented as 100001. Uniqueness is restored when using CSDs by requiring that a 1 and a 1) always be followed by a 0. This results in a proliferation of 0s in long, random, CSD binary numbers, with the likelihood of a 1 or a 1 approaching ⅓ rather than ½ as in ordinary binary numbers.

The use of CSD in digital filters is known to bring substantial savings for performing numerical operations, particularly when performing multiplications. For example, operations on the binary number 11111 require four additions when forming a product with a multiplicand, whereas using the corresponding CSD representation 100001 of the same number requires only one subtraction. The use of CSD, which represents binary numbers with the smallest number of “1” bits, generally results in about a one-third reduction in the number of numerical operations to form a binary product, particularly for binary numbers represented with a large number of bits. As an example of substantial reduction of corresponding computation in ordinary base-10 arithmetic, multiplying a long number by 99 can be easily performed by first multiplying the number by 100 (by moving the decimal point two places to the right), and then just subtracting the original number.

Other prior research efforts have produced further simplifications to the computational effort necessary to support FIR filters and include:

using FIR filters with symmetrical (or anti-symmetrical) impulse responses that inherently maintain linear phase delay in the output signal. Such filters can be implemented with half as many multiplications as a non-symmetrical filter.

using “half-band filters,” which are filters that have transforms that are even functions of frequency and which have odd symmetry about a half-bandwidth point, which produce both a symmetric impulse time response as well as a zero impulse time response for the even-numbered time steps, obviating the need to calculate the response at the even-numbered points.

using time step “decimation,” i.e., reducing the number of points at which a filter response needs to be calculated by a factor of M, and constraining M to be 2ⁿ where n is an integer exponent, i.e., 2ⁿ=2, 4, 8, 16, . . . , etc., which reduces the necessary computation by about a factor of M.

structuring a decimation filter as a series of cascaded stages, with each stage operating with smaller steps of decimation, and configuring the more rapidly executed steps with lower order filters.

using efficient digital structures such as tree adders to perform arithmetic operations in minimal time.

Nonetheless, even when these known simplifications are included in the filter design, a significant amount of repetitive numerical computation is still required for a high-order filter, contributing a substantial cost adder that adversely affects the design of digital systems in such applications. A need thus exists for a filter design which results in a further reduction in the number of arithmetic steps that must be performed when implementing an FIR or IIR filter.

### SUMMARY OF THE INVENTION

The prior art approach uses a digital filter to produce an output signal from samples of an input signal using delay elements that produce delayed samples of the input signal, filter coefficients that multiply delayed samples of the input signal to produce products, and an adder that sums products. The prior art uses CSD and other digital efficiencies to reduce the computational load for a digital filter. Embodiments of the present invention achieve technical advantages by selecting the coefficients for a digital filter by an optimal filter coefficient search that minimizes or reduces the number of nonzero binary digits in the filter coefficients, while satisfying a filter performance criterion. In another aspect of the present invention, the filter coefficients are selected by an optimal filter coefficient search to minimize or reduce the filter execution time while satisfying a filter performance criterion. In a further aspect, the optimal filter coefficient search to minimize or reduce the number of nonzero binary digits in the filter coefficients includes coefficient scaling by multiplying filter coefficients by a pre-scaling constant. In a further aspect, the optimal filter coefficient search to minimize or reduce the number of nonzero binary digits in the filter coefficients that preferably includes coefficient scaling by adding a constant to filter coefficients. Preferably, the filter coefficients are expressed in canonical signed digits. In a further aspect, the optimal filter coefficient search to minimize or reduce the number of nonzero binary digits in the filter coefficients includes using a given precision and an allowable number of nonzero digits in filter coefficients. Digital filters configured with coefficients produced using a coefficient search of the present invention that preferably uses coefficient scaling can exhibit a reduction of the number of nonzero digits in filter coefficients that may be 3-to-1 or more over a prior-art approach using CSD and other known digital simplifications, which can have a significant impact on the resulting end-product design. A preferred embodiment of the present invention reduces the number of nonzero binary digits in all filter coefficients; a low cost alternative reduces the number of nonzero binary digits in a plurality of the filter coefficients.

In accordance with another preferred embodiment of the present invention a digital signal processing system is configured with a digital filter with filter coefficients that are selected by an optimal filter coefficient search to minimize or reduce the number of nonzero binary digits in the filter coefficients that preferably uses coefficient scaling, while satisfying a filter performance criterion. In another aspect, the filter coefficients are selected by an optimal filter coefficient search that preferably uses coefficient scaling to minimize or reduce the filter execution time while satisfying a filter performance criterion. In a further aspect, the optimal filter coefficient search to minimize or reduce the number of nonzero binary digits in the filter coefficients preferably uses coefficient scaling by multiplying filter coefficients by a pre-scaling constant. In a further aspect, the optimal filter coefficient search to minimize or reduce the number of nonzero binary digits in the filter coefficients preferably uses coefficient scaling by adding a constant to filter coefficients. Preferably, the filter coefficients are expressed in canonical signed digits. In a further aspect, the optimal filter coefficient search to minimize or reduce the number of nonzero binary digits in the filter coefficients includes using a given precision and an allowable number of nonzero digits in filter coefficients.

Another embodiment of the present invention is a method of configuring a digital filter by selecting filter coefficients using an optimal filter coefficient search that preferably uses coefficient scaling to minimize or reduce a number of nonzero binary digits in the filter coefficients while satisfying a filter performance criterion. In another aspect, the method further includes selecting the filter coefficients using an optimal filter coefficient search to minimize or reduce the filter execution time while satisfying a filter performance criterion. In a further aspect, the method includes minimizing or reducing the number of nonzero binary digits in the filter coefficients preferably by scaling the filter coefficients by multiplying filter coefficients by a pre-scaling constant in the filter coefficient search. In a further aspect, the method includes minimizing or reducing the number of nonzero binary digits in the filter coefficients preferably by scaling the filter coefficients by adding a constant to filter coefficients in the optimal filter coefficient search to simplify computation. Preferably, the method includes expressing filter coefficients using canonical signed digits. In a further aspect, the method includes using a given precision and an allowable number of nonzero digits in filter coefficients in the optimal filter coefficient search to minimize or reduce the number of nonzero binary digits in the filter coefficients.

Embodiments of the present invention achieve technical advantages as an improved digital filter to process sampled data. Advantages of embodiments of the present invention include a digital filtering device with reduced die area and reduced manufacturing cost that can implement a high performance filtering task with rapid throughput.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an exemplary block diagram structure for an FIR filter;

FIG. 2 illustrates a flow chart for the search process of the present invention;

FIG. 3 illustrates attenuation of an FIR filter implemented with floating-point filter coefficients and attenuation of an FIR filter implemented with filter coefficients of the present invention;

FIG. 4 illustrates the time response to a step input of an FIR filter implemented with floating-point filter coefficients; and

FIG. 5 illustrates the time response to a step input of an FIR filter implemented with filter coefficients of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments of the present invention will be described with respect to preferred embodiments in a specific context, namely a digital device configured with an FIR or IIR filter for a signal processing application. The invention may be applied to video and audio signal processing applications such as television and radio receivers, systems for recording and play-back of entertainment media, speech processing, character recognition, radar and sonar systems, and others.

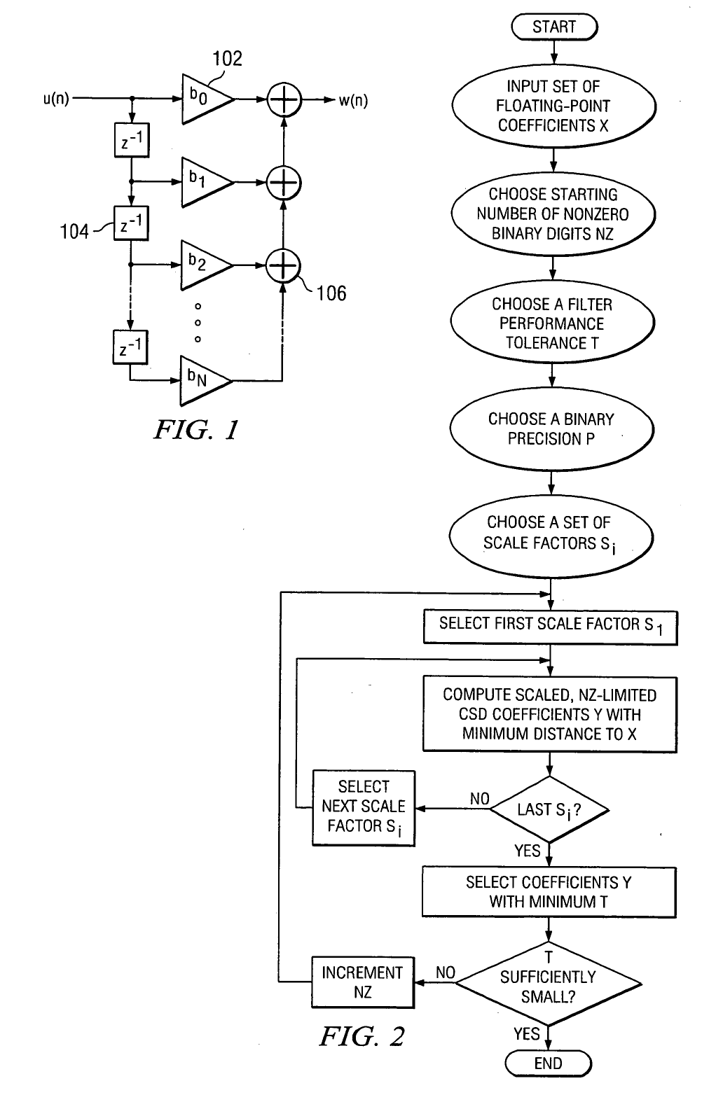

With reference to FIG. 1, illustrated is a representative block diagram showing a structure for an N-tap FIR filter that receives a sampled input signal u(n) and produces a filtered, sampled output signal w(n). The structure of a filter designed with the prior art and a filter designed with coefficients determined by an optimal coefficient search of the present invention can both be represented by the exemplary structure illustrated in FIG. 1. However, the computation required by the two design approaches is substantially different, as described hereinbelow. The input signal to the filter is sequentially delayed by delay blocks such as delay block 104, indicated by the z-transform of a single sample step delay z⁻¹. The input signal and the delayed samples are multiplied by the filter gains (“coefficients”) b₀, b₁, . . . , b_{N}, which are usually constant, and the products are summed by adders such as 106 to produce the filtered output signal w(n). As indicated above, the number of delay blocks, multiplying filter gains, such as filter gain 102, and adders, can often be 100 or more in FIR filter designs used in high-performance systems. When the input signal u(n) is sampled at a high sampling rate, such as 44.1 kHz or higher as used in high-performance audio systems such as CD players, or at even higher sampling rates as used in video systems, the need for rapid digital signal processing, particularly when sampling with 16 bits or more of precision, can easily challenge the computational limits of silicon digital circuits that are economically produced with ordinary integrated-circuit fabrication technology when designed with the prior art.

To reduce the hardware or software computation required by the filter, particularly when using an integrated circuit implementation, filters are ordinarily configured with constant coefficients and with high speed “multiplierless” digital logic in which the operation of multiplication is performed with a series of binary shifts and adds. The cost and speed of the resulting filter is dependent on the number of ones in the resulting binary filter coefficients which produce the shifts and adds required to perform a multiplication. A numerical approach using ordinary CSD arithmetic thus has an advantage over ordinary binary arithmetic, such as the twos-complement binary arithmetic frequently used in digital systems.

It is desired to produce a set of coefficients for a prescribed filter with the smallest number of ones. The process implemented by the present invention makes a reduction in the number of ones that appear in the filter coefficients beyond that which is attainable using CSD arithmetic alone. The present invention preferably continues to use CSD arithmetic. However, other arithmetic systems, such as a system using twos-complement binary arithmetic, can also be used within the scope of the present invention.

To obtain a set of filter coefficients with the smallest number of ones, the process of the present invention selects a set of filter coefficients with a reduced number of nonzero bits by performing a search over an admissible coefficient solution search space that satisfies a filter specification. In addition, a multiplicative gain factor and/or an additive term are preferably applied to the filter to extend the space over which the search can be performed for filter coefficients with the smallest number of nonzero bits. The resulting filter, including a filter with a multiplicative gain factor or an additive term, can be readily used in a signal-processing system by making a compensating adjustment elsewhere to a system gain or an off-set, such as by making an adjustment to an analog-to-digital (A/D) or a digital-to-analog (D/A) conversion process. Such gain changes or off-set changes can usually be readily made by making a simple compensating change to a reference voltage or to a reference resistance in an A/D or a D/A conversion process.

The filter design process of the present invention utilizes a filter design tolerance such as a tolerance for a pass band and stop band attenuation factor, or a tolerance for the transition between a pass band and a stop band. A solution search space for possible filter coefficients is generated to allow a filter cost such as the number of nonzero binary digits in the filter coefficients to be optimized over the prior art by examining a range of admissible filters that satisfy the filter design tolerance. Preferably, the solution search space includes a multiplicative gain factor for the filter coefficients or an additive term for the filter coefficients, or both.

As an example of the savings that can be made by such a search, the process of the present invention is illustrated for the simple case of a two-coefficient filter that uses ordinary base-10 arithmetic. This example filter multiplies a sampled input signal by 0.76845, then multiplies the delayed signal by 0.845295, and adds the result. These two filter coefficients with many digits ordinarily require a substantial amount of computation. However, if the overall filter gain is increased for this example by the factor 1/0.76845, then the filter coefficients become 1.00000 and 1.10000, which results in simple enough arithmetic that it can be done by hand, certainly for one input sample, because the base-10 computation now only involves a simple shift and two adds for the filtering process.

Similarly, a filter with a coefficient of 0.999987 might be rounded to 1.00000 when using base-10 arithmetic without the filter exceeding a specification performance limit.

The savings in digital computation resulting from exploring a solution search space of admissible filter coefficient using the design process of the present invention are potentially enormous in many applications, particularly when using an expanded search space that includes a multiplicative gain factor for the filter coefficients, or an additive term, or both.

An exemplary optimum coefficient search process of the present invention starts with an initial set of filter coefficients represented by X=x₁, x₂, . . . , x_{N}, that are typically represented in floating-point, decimal arithmetic with high precision. Such an initial set of filter coefficients can be determined by various techniques that are well known in the art such as from a specification of the filter impulse response function or from a specification of a filter transform function. The filter coefficients for an FIR filter are just the impulse response function sample points, and are thus easily determined. Preferably, the filter coefficients are converted to a binary CSD representation Y=y₁, y₂, . . . , y_{N}.

A precision “P” for the binary filter coefficients in the solution search space is given or chosen such as 10 bits. The precision “P” represents the smallest power of 2 used in the creation of the solution search space, and is the number of bits that will be used to represent each coefficient. A number of allowable nonzero digits “NZ” in a filter coefficient (the maximum number of CSD digits 1 or −1 in a filter coefficient) after conditioning by the search process is also specified. A practical number for NZ has been found from experience to be 3 or 4, but other numbers such as 2 or 5 or more may be useful.

A set of pre-scaling gain factors “S” is chosen. A pre-scaling gain factor S is a multiplicative factor for all the filter coefficients. Alternatively, an additive term for all the filter gains can be used, or a combination of an additive term and a multiplicative factor can be used. In the following discussion, only the use of a multiplicative factor will be described, but the process to use an additive term or a combination of a multiplicative factor and an additive term will be obvious to one skilled in the art. An exemplary set of numbers for a multiplicative pre-scaling factor “S” is the set {0.5, 0.6, 0.7, . . . , 1.5}. Other sets of multiplicative pre-scaling factors, including sets of random numbers, can be used, and are well within the broad scope of the present invention. The technique of including a pre-scaling multiplicative factor or an additive term expands the solution search space with the objective, for example, of finding a more area-efficient solution for an integrated circuit compared to what can be achieved by a CSD representation of the original floating point filter coefficients alone.

A solution search space is created consisting of all the possible CSD coefficients for a given set of filter coefficients “X”, and the set of pre-scaling factors “S”. For each floating-point filter coefficient scaled by the factor S, one point is chosen in the CSD solution search space that corresponds to the minimum difference between the floating point coefficient and that point in the solution search space. Alternatively, if a scaling factor S is not used in the creation of a solution search space, a point can be chosen in the CSD or otherwise limited solution search space that corresponds to the minimum difference between the floating point coefficient and that point in the solution search space.

The optimization process searches over the solution search space and starts with the initial set of filter coefficients “X”. A CSD representation “Y” with the number of nonzero binary digits in each coefficient limited to NZ for the candidate filter coefficients in the solution search space is computed with precision P for each of the filter coefficients. The coefficients Y can be chosen with a minimum distance to each original filter coefficient X. For this discussion, a CSD filter coefficient Yᵢ is assumed to be of the form Yᵢ=0.y_{P}, y_{P-1}, . . . , y₁, i.e., −1<Yᵢ<1.

An alternative criterion for the choice of a point in the solution search space is the error in the frequency domain between the original transfer function for the filter coefficients X and the transfer function obtained with that filter coefficient represented as the prospective CSD (or binary representation) from the solution search space. This criterion can obtain filter simplification results that are comparable to minimizing the difference between the floating point coefficient and the CSD point (or binary representation of a point) in the solution search space. The error in the frequency domain can be measured as an integrated mean-square difference of transfer functions over frequency, or a maximum absolute transfer function difference, or other measure of a difference as a consequence of selecting the point in the solution search space as is well understood in the art. This results in a possible set of optimized CSD (or binary representation of) filter coefficients “Z”.

The frequency responses for filters using the coefficients Z is then computed. If the frequency response for the filter using the set of possible CSD coefficients Z is within acceptable limits, then this filter is recorded as a candidate solution.

If the frequency response for the filter coefficients given by Z is not within an acceptable limit, then this solution is rejected, and the process is repeated for a different S, and then with a different P, and then with a different NZ.

The set of candidate filter coefficient solutions from searching over the solution search space of S, P, and NZ is “C”. For each member of the set of candidate solutions C, the transient response for that filter is compared to the filter that uses the original filter coefficients represented in floating-point arithmetic. If the transient response is not acceptable, then that member is removed.

The remaining members of the set of candidate solutions is sorted based on the required number of add and subtract operations, and the member with the smallest number of add and subtract operations is chosen. Alternatively, the member satisfying a different selection criterion such as an area of an integrated circuit based on the set of coefficients can be used.

A flow chart illustrating an exemplary search process over a solution search space is shown in FIG. 2. The search process starts with a limiting number of nonzero binary digits NZ, an original filter design represented by a set of filter coefficients X, a filter performance limit T for choosing an acceptable filter, a binary precision P, and a set of scale factors S. The process iterates on the scale factors S and the limiting number of nonzero binary digits NZ. The search process can be extended, for example and without limitation, by including further iteration on the set of scale factors S, adjustments to the filter performance limit T, etc.

The execution time of a search engine programmed to perform this optimization technique for typical filters targeting hardware or software implementation is generally of the order of a few seconds. This extra step of optimization can be added to design cycles with no discernible impact on the development cycle. However, the hardware savings, the simplification of the filter architecture, and its impact on the design time justify the exploration.

Other mathematical optimization techniques, such as linear programming or Lagrangian optimization, to find a filter solution with a minimum or reduced cost or error function are well within the broad scope of the present invention. The implementation of the optimization technique can be made in software applications such as MatLab™ or in other software applications, and may use a high-level programming language such as “C”.

The results of using of this technique can be illustrated by an exemplary, low-pass FIR filter with 23 coefficients that can be used in a video application. The filter coefficients are determined from the set of 23 numbers:
[−32, −81, −30, 139, 192, −101, −383, 437, 3505, 8409, 13152, 15122, 13152, 8409, 3505, 437, −383, −101, 192, 139, −30, −81, −32]

where each number in the set above is divided by 2¹⁶=65536 to produce filter coefficients with magnitude less than unity for use in a fixed-point arithmetic scheme. In the table below, the filter coefficients are listed, followed by their CSD representation, the corresponding adds and subtracts to perform a multiply operation, and the total count of adds and subtracts for this low-pass filter (LPF).

| | | | Count of | |
|---|---|---|---|---|
| Filter | | Coefficients Represented | Adds and | |
| Coefficient | CSD Representation | as Shift/Add/Subtract | Subtracts | |
| −32./65536 | 0000 00-10 0000 | −2⁻¹¹ | 0 | add/sub |
| −81./65536 | 0000 0-10-1 000-1 | −2⁻¹⁰ − 2⁻¹² − 2⁻¹⁶ | 2 | add/sub |
| −30./65536 | 0000 00-10 0010 | −2⁻¹¹ + 2⁻¹⁵ | 1 | add/sub |
| 139./65536 | 0000 1001 0-10-1 | 2⁻⁹ + 2⁻¹² − 2⁻¹⁴ − 2⁻¹⁶ | 3 | add/sub |
| 192./65536 | 0001 0-100 0000 | 2⁻⁸ − 2⁻¹⁰ | 1 | add/sub |
| −101./65536 | 0000 -1010 0-10-1 | −2⁻⁹ + 2⁻¹¹ − 2⁻¹⁴ − 2⁻¹⁶ | 3 | add/sub |
| −383./65536 | 00-10 1000 0001 | −2⁻⁷ + 2⁻⁹ + 2⁻¹⁶ | 2 | add/sub |
| 437./65536 | 0010 0-10-1 0101 | 2⁻⁷ − 2⁻¹⁰ − 2⁻¹² + 2⁻¹⁴ + 2⁻¹⁶ | 4 | add/sub |
| 3505./65536 | 0001 00-10 0-10-1 | 2⁻⁴ − 2⁻⁷ − 2⁻¹⁰ − 2⁻¹² + 2⁻¹⁶ | 4 | add/sub |
| | 0001 | | | |
| 8409./65536 | 0010 0001 00-10 - | 2⁻³ + 2⁻⁸ − 2⁻¹¹ − 2⁻¹³ + 2⁻¹⁶ | 4 | add/sub |
| | 1001 | | | |
| 13152./65536 | 010-1 0100 -10-10 | 2⁻² − 2⁻⁴ + 2⁻⁶ − 2⁻⁹ − 2⁻¹¹ | 4 | add/sub |
| | 0000 | | | |
| 15122./65536 | 0100 0-10-1 0001 | 2⁻² − 2⁻⁶ − 2⁻⁸ + 2⁻¹² + 2⁻¹⁵ | 4 | add/sub |
| | 0010 | | | |
| 13152./65536 | 010-1 0100 -10-10 | 2⁻² − 2⁻⁴ + 2⁻⁶ − 2⁻⁹ − 2⁻¹¹ | 4 | add/sub |
| | 0000 | | | |
| 8409./65536 | 0010 0001 00-10 - | 2⁻³ + 2⁻⁸ − 2⁻¹¹ − 2⁻¹³ + 2⁻¹⁶ | 4 | add/sub |
| | 1001 | | | |
| 3505./65536 | 0001 00-10 0-10-1 | 2⁻⁴ − 2⁻⁷ − 2⁻¹⁰ − 2⁻¹² + 2⁻¹⁶ | 4 | add/sub |
| | 0001 | | | |
| 437./65536 | 0000 0010 0-10-1 | 2⁻⁷ − 2⁻¹⁰ − 2⁻¹² + 2⁻¹⁴ + 2⁻¹⁶ | 4 | add/sub |
| | 0101 | | | |
| −383./65536 | 00-10 1000 0001 | −2⁻⁷ + 2⁻⁹ + 2⁻¹⁶ | 2 | add/sub |
| −101./65536 | 0000 -1010 0-10-1 | −2⁻⁹ + 2⁻¹¹ − 2⁻¹⁴ − 2⁻¹⁶ | 3 | add/sub |
| 192./65536 | 0001 0-100 0000 | 2⁻⁸ − 2⁻¹⁰ | 1 | add/sub |
| 139./65536 | 0000 1001 0-10-1 | 2⁻⁹ + 2⁻¹² − 2⁻¹⁴ − 2⁻¹⁶ | 3 | add/sub |
| −30./65536 | 0000 00-10 0010 | −2⁻¹¹ + 2⁻¹⁵ | 1 | add/sub |
| −81./65536 | 0000 0-10-1 000-1 | −2⁻¹⁰ − 2⁻¹² − 2⁻¹⁶ | 2 | add/sub |
| −32./65536 | 0000 00-10 0000 | −2⁻¹¹ | 0 | add/sub |
| LPF Total | | | 60 | adds/subs |

The filter coefficients in this example are symmetric, which implies an arithmetic savings in a hardware or software filter implementation as is well understood in the art. However, for simplicity of explanation, the optimization using filter symmetry is not initially included in the present example.

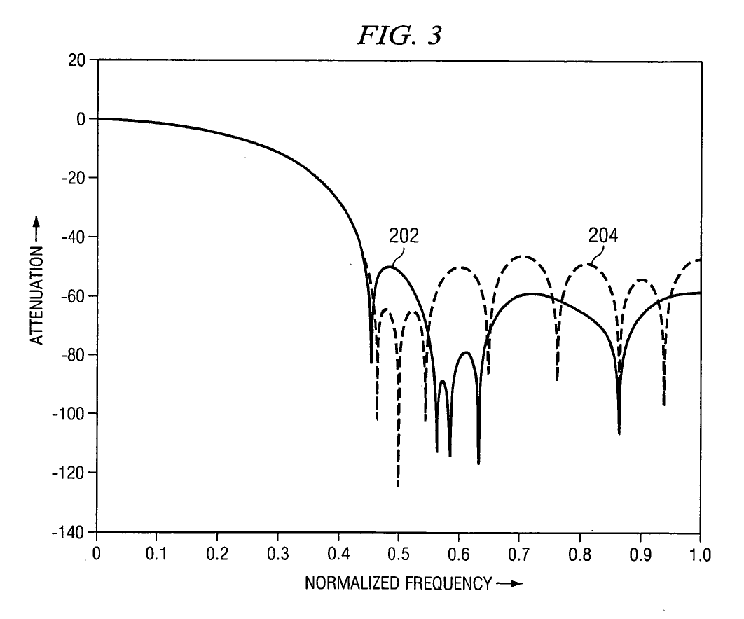

The frequency response of the original floating-point coefficient filter is illustrated by the solid curved line 202 in FIG. 3.

The previously described 23-coefficient filter was then optimized using the search process of the present invention. The optimization parameters used were NZ=3, P=10, and S=1.4375. The optimized filter coefficients, the corresponding shifts, adds, and subtracts, and the count of the total optimized adds and subtracts for this LPF is shown in the table below.

| CSD Optimized | | Count of |
|---|---|---|
| Filter | Coefficients Represented as | Adds and |
| Coefficients | Shifts/Adds/Subtracts | Subtracts |
| 0.000000 | 0 | 0 add/sub |
| −0.003906 | −2⁻⁸ | 0 add/sub |
| 0.000000 | 0 | 0 add/sub |
| 0.003906 | +2⁻⁸ | 0 add/sub |
| 0.003906 | +2⁻⁸ | 0 add/sub |
| −0.003906 | −2⁻⁸ | 0 add/sub |
| −0.011719 | −2⁻⁶ + 2⁻⁸ | 1 add/sub |
| 0.011719 | 2⁻⁶ − 2⁻⁸ | 1 add/sub |
| 0.097656 | 2⁻³ − 2⁻⁵ + 2⁻⁸ | 2 add/sub |
| 0.234375 | 2⁻² − 2⁻⁶ | 1 add/sub |
| 0.367188 | +2⁻¹ − 2⁻³ − 2⁻⁷ | 2 add/sub |
| 0.421875 | +2⁻¹ − 2⁻⁴ − 2⁻⁶ | 2 add/sub |
| 0.367188 | +2⁻¹ − 2⁻³ − 2⁻⁷ | 2 add/sub |
| 0.234375 | 2⁻² − 2⁻⁶ | 1 add/sub |
| 0.097656 | 2⁻³ − 2⁻⁵ + 2⁻⁸ | 2 add/sub |
| 0.011719 | 2⁻⁶ − 2⁻⁸ | 1 add/sub |
| −0.011719 | −2⁻⁶ + 2⁻⁸ | 1 add/sub |
| −0.003906 | −2⁻⁸ | 0 add/sub |
| 0.003906 | 2⁻⁸ | 0 add/sub |
| 0.003906 | 2⁻⁸ | 0 add/sub |
| 0.000000 | 0 | 0 add/sub |
| −0.003906 | −2⁻⁸ | 0 add/sub |
| 0.000000 | 0 | 0 add/sub |
| LPF Total | | 16 add/sub |

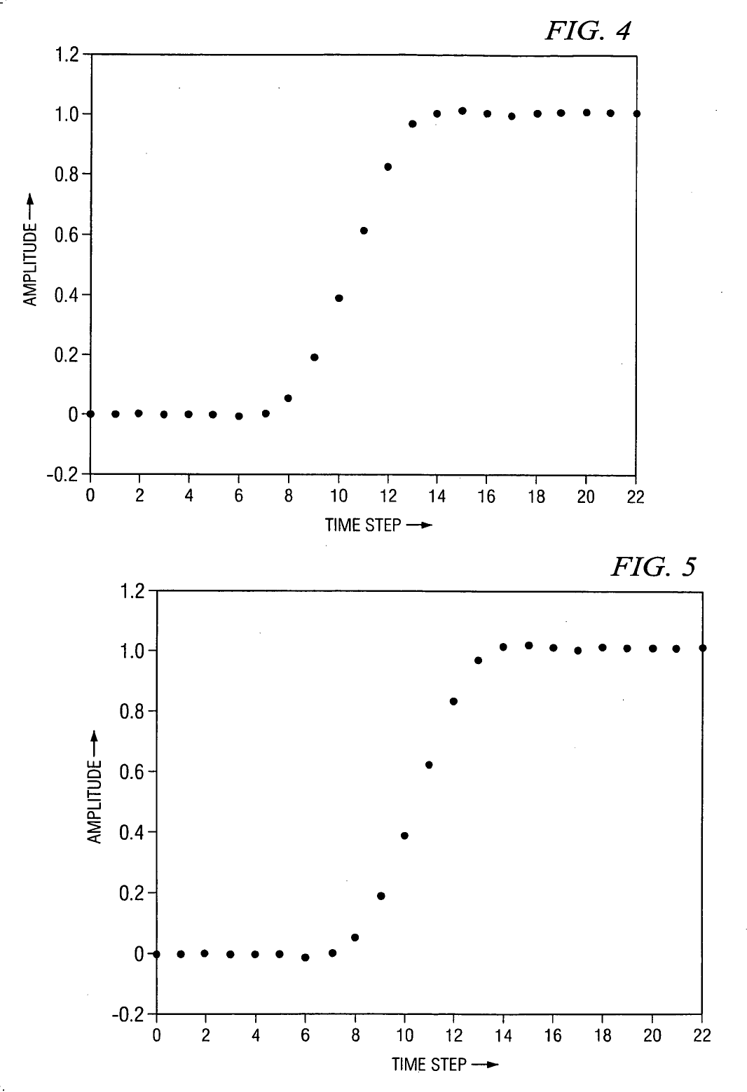

The optimization process reduces the 60 adds and subtracts in the original filter to 16 in the optimized filter. The frequency response of the optimized filter is shown in FIG. 3 as the broken line 204. The step response of the original filter for an input step of unity amplitude is illustrated in FIG. 4, and the corresponding step response of the optimized filter is illustrated in FIG. 5.

The step response for the original filter fluctuates between 0.995 and 1.005 around the steady-state value of 1.0. The step response of the CSD optimized filter fluctuates between 0.996 and 1.0069 around the steady-state value of 1.0.

The hardware savings in terms of the number of adds and subtracts exceeds 70% in this 23-coefficient example. The original CSD implementation requires 60 adds and subtracts, and the optimized filter requires only 16.

If symmetry of the filter coefficients is now taken into consideration, a symmetric implementation of the original CSD filter would require 32 adds and subtracts. The number of adds and subtracts required for the optimized symmetric filter is 9. The percentage of hardware or software reduction for this example is not notably different when the symmetry of the filter is exploited.

This optimization technique of performing a search for coefficients with minimal 1s or 1s over a solution search space is not restricted to low-pass filters. Any type of FIR or IIR filter such as a band stop filter or a high pass filter, particularly a filter with many coefficients, is a candidate for optimization.

As a further example of filter optimization, a band-pass filter used in an audio application and configured with 41 coefficients was optimized using the search process of the present invention. The optimization parameters used in the search were NZ=3, P=10, and S=1.4375. The 89 adds and subtracts required for the original filter implementation were reduced to 40.

The optimization technique of the present invention for a digital filter with a performance tolerance as described above can be configured as a computer program product containing a set of instructions for designing the digital filter. The computer program product may include a medium with a computer program embodied on it. The computer program may include a user interface for inputting design factors such as a number of nonzero digits, a binary precision, a set of scale factors, and a filter performance tolerance. In addition, the computer program may be configured to include a set of instructions for computing binary filter coefficients for a set of filters with the inputted binary precision that are scaled by the set of scale factors, and limiting the number of nonzero binary digits in each scaled filter coefficient by the inputted number of nonzero digits. A filter with the limited number of nonzero binary digits in the coefficients is selected from the set of filters that satisfies the filter performance tolerance.

Although embodiments of the present invention and its advantages have been described in detail, it should be understood that various changes, substitutions and alterations can be made herein without departing from the spirit and scope of the invention as defined by the appended claims. For example, it will be readily understood by those skilled in the art that alternative search techniques and numerical methods to form filters providing a reduced computational burden for digital logic as described herein may be varied while remaining within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A digital filter with a performance tolerance that produces an output signal from samples of an input signal, comprising:
delay elements that produce delayed samples of the input signal;
filter coefficients that multiply the delayed samples of the input signal to produce products; and
an adder that sums the products, wherein the filter coefficients are selected by a filter coefficient search process that includes scaling at least a plurality of the filter coefficients to reduce filter implementation cost while satisfying the filter performance tolerance.

2. The digital filter according to claim 1, wherein the filter coefficient search to reduce the filter implementation cost includes scaling filter coefficients by multiplying the filter coefficients by a pre-scaling constant.

3. The digital filter according to claim 1, wherein the filter coefficient search to reduce the filter implementation cost includes scaling filter coefficients by adding a constant to the filter coefficients.

4. The digital filter according to claim 1, wherein the filter coefficients are expressed in canonical signed digits.

5. The digital filter according to claim 1, wherein the filter coefficient search to reduce the filter implementation cost includes using a precision and an allowable number of nonzero digits in at least a plurality of the filter coefficients.

6. The digital filter according to claim 1, wherein the filter implementation cost is the number of nonzero bits in the filter coefficients.

7. The digital filter according to claim 1, wherein the number of nonzero binary digits in at least a plurality of the filter coefficients is less than five.

8. A digital signal processing system including a digital filter with a performance tolerance that produces an output signal from samples of an input signal, comprising:
delay elements that produce delayed samples of the input signal;
filter coefficients that multiply the delayed samples of the input signal to produce products; and
an adder that sums the products, wherein the filter coefficients are selected by a filter coefficient search process that includes scaling the filter coefficients to reduce a filter implementation cost while satisfying the filter performance tolerance.

9. The digital signal processing system according to claim 8, wherein the filter coefficient search to reduce the filter implementation cost includes scaling the filter coefficients by multiplying the filter coefficients by a pre-scaling constant.

10. The digital signal processing system according to claim 8, wherein the filter coefficient search to reduce the filter implementation cost includes scaling the filter coefficients by adding a constant to the filter coefficients.

11. The digital signal processing system according to claim 8, wherein the filter coefficients are expressed in canonical signed digits.

12. The digital signal processing system according to claim 8, wherein the filter coefficient search to reduce the filter implementation cost includes using a precision and an allowable number of nonzero digits in at least a plurality of the filter coefficients.

13. The digital signal processing system according to claim 8, wherein the filter implementation cost is the number of nonzero bits in the filter coefficients.

14. A method of configuring a digital filter with a performance tolerance to produce an output signal from samples of an input signal, comprising:
producing delayed samples of the input signal with delay elements;
multiplying the delayed samples of the input signal by filter coefficients to produce products; and
summing the products with an adder, wherein the filter coefficients are selected by employing a filter coefficient search process that includes scaling the filter coefficients to reduce a filter implementation cost while satisfying the filter performance tolerance.

15. The method according to claim 14, including scaling the filter coefficients by multiplying the filter coefficients by a pre-scaling constant in the filter coefficient search to reduce the filter implementation cost.

16. The method according to claim 14, including scaling the filter coefficients by adding a constant to the filter coefficients in the filter coefficient search to reduce the filter implementation cost.

17. The method according to claim 14, including expressing the filter coefficients using canonical signed digits.

18. The method according to claim 14, including using a precision and an allowable number of nonzero digits in at least a plurality of the filter coefficient in the filter coefficient search to reduce the filter implementation cost.

19. The method according to claim 14, including using the number of nonzero bits in the filter coefficients as the filter implementation cost.

20. A method of designing a digital filter with a performance tolerance to produce an output signal from samples of an input signal, comprising the steps of:
designing an original filter with filter coefficients;
selecting a number of nonzero binary digits;
identifying a filter performance tolerance;
choosing a binary precision;
selecting a set of scale factors;
computing binary filter coefficients for the filter coefficients scaled by a scale factor and limiting the number of nonzero binary digits in each scaled filter coefficient; and
selecting a filter with binary filter coefficients with the limited number of nonzero binary digits that satisfies the filter performance tolerance.

21. The method according to claim 20, including using canonical signed digits for the binary filter coefficients.

22. The method according to claim 20, including using a multiplicative factor for the scale factor.

23. The method according to claim 20, including using an additive term for the scale factor.

24. A computer program product containing a set of instructions for designing a digital filter with a performance tolerance, said digital filter producing an output signal from samples of an input signal, the computer program product having a medium with a computer program embodied thereon, the computer program comprising:
a user interface for inputting a number of nonzero digits, a binary precision, a set of scale factors, and a filter performance tolerance; and
a set of instructions that computes binary filter coefficients for filter coefficients for a set of filters scaled by the set of scale factors wherein the number of nonzero binary digits in each scaled filter coefficient is limited by the number of nonzero digits and a filter with binary filter coefficients with the binary precision and the limited number of nonzero binary digits is selected from the set of filters that satisfies the filter performance tolerance.

25. The computer program product according to claim 24, wherein the computer program product contains code to express filter coefficients in canonical signed digits.

26. The computer program product according to claim 24, wherein the computer program product contains code to use a multiplicative factor for the scale factor.

27. The computer program product according to claim 24, wherein the computer program product contains code to use an additive term for the scale factor.
